(19) United States
(12) Patent Application Publication
(10) Pub. No.: US 2021/0283712 A1
(43) Pub. Date: Sep. 16, 2021

(54) METHOD FOR CONNECTING AT LEAST TWO COMPONENT LAYERS BY MEANS OF PLASMA JET PRE-DRILLING OF THE COVER LAYER

(71) Applicant: EJOT GmbH & Co. KG, Bad Berleburg (DE)

(72) Inventors: Christian REIS, Luebbecke (DE); Gerson MESCHUT, Bielefeld (DE)

(21) Appl. No.: 16/326,628

(22) PCT Filed: Aug. 21, 2017
(86) PCT No.: PCT/EP2017/071013

§ 371 Date: Feb. 19, 2019

(30) Foreign Application Priority Data
Aug. 19, 2016 (DE) 10 2016 115 463.6

(51) Int. Cl. B23K 20/12; B21J 5/06; B23K 20/24; B23K 20/22; B23K 35/02

(52) U.S. Cl. CPC B23K 20/127; B21J 5/066; B23K 20/24; B23K 2101/18; B23K 20/22; B23K 35/0255; B23K 20/129

(57) ABSTRACT

The invention relates to a method for connecting at least two component layers by means of a connection element. the invention to provide a particularly advantageous method for connecting at least two component layers lying on top of each other through the creation of a pilot hole in at least one cover layer. The pilot hole in the form of a through hole is made in the at least one cover layer using only a plasma jet, which cover layer is at least temporarily held in place on the base layer. Holding the cover layer and the base layer temporarily fixed to each other will allow the connection element to be placed at the same position in the base layer where the pilot hole is made. Sufficiently large layers can thus be kept in a fixed position relative to one another solely using their weight and friction.

The invention relates to a method for connecting at least two component layers by means of a connection element as specified in the preamble of claim 1.

In order to connect two plate-like components to be joined, it is necessary, as known from DE 196 30 518 C2, for example, to create a through hole and to connect the two component layers by means of a connection element. The disadvantage of this type of connection is that a through hole will only allow the use of a limited number of connection methods, and in particular is restricted to the use of self-tapping screws.

This disadvantage can be eliminated if at least two component layers are connected by means of one connection element, for which purpose a pilot hole is made in the top layer without pre-drilling into a base layer in the region of the pilot hole. A connection element having a shoulder is regularly connected to the base layer through the pilot hole in the cover layer, which connection element uses its shoulder to hold the cover layer in place. Such a method is known, for example, from DE 10 2012 005 203 A1. A similar method is disclosed in DE 10 2004 042 622 B4.

However, joining methods using pilot holes are usually problematic regarding pilot hole machining which results in high wear and contamination of the environment, as is the case with milling, drilling, cutting or punching methods. This applies in particular to the processing of high-strength or ultrahigh-strength sheet metals, such as 22MnB5.

It is the object of the invention to provide a particularly advantageous method for connecting at least two component layers lying on top of each other, comprising the creation of a pilot hole in at least one cover layer.

This object is accomplished by the features of the characterizing part of claim 1 in conjunction with the features specified in its preamble.

The subclaims represent advantageous embodiments of the invention.

In a known manner, in a method for connecting at least two component layers by means of a connection element, with one component layer thereof comprising at least one cover layer and at least one base layer, a pilot hole is made in the cover layer, without pre-drilling into a base layer in the region of the pilot hole. Through the pilot hole in the cover layer, a connection element with a shoulder is inserted into the pilot hole and connected to the base layer. The connection element uses its shoulder to hold the cover layer in place and is positively connected and/or firmly bonded and/or force locked to the base layer.

In accordance with the invention, it is provided that the pilot hole in the form of a through hole is made in the at least one cover layer using only a plasma jet, which cover layer is at least temporarily held in place on the base layer. Holding the cover layer and the base layer temporarily fixed to each other will allow the connection element to be placed at the same position in the base layer where the pilot hole is made. Sufficiently large layers can thus be kept in a fixed position relative to one another solely using their weight and friction. Another way of fixing the two layers is by using connecting structures to secure the two layers in place relative to one another with as little movement as possible, or by fixing them relative to each other using external retaining devices or hold-down means. Following the creation of the pilot hole in the cover layer, the connection element is then passed through the cover layer, i.e. the pilot hole in the cover layer, and connected to the base layer that does not have a pilot hole in it. The pilot hole creation process will therefore be terminated as soon as a through hole has been made in said at least one cover layer, with the base layer still largely intact, at any rate without any through hole in it yet. The pilot hole making process is terminated by switching off the plasma jet after a preset period of time, which is dependent, amongst others, on the distance between the nozzle and the cover plate, the gas pressure, the geometry of the nozzle, the energy of the arc, the type of gas and the dimension of the pilot hole to be made in the respective material.

The respective parameter settings on which the method is based are determined for each individual case and are then available as input variables for the pilot hole making process.

Using a plasma jet to create a pilot hole also allows making a pilot hole in a hard or ultra-hard cover layer on a softer base layer without causing any deformation of the assembly. Within the scope of the invention, component layers can also be processed that have an adhesive layer between the base layer and the cover layer which has been applied for later curing. In particular, the cover layer is harder than the base layer.

According to a preferred embodiment of the method, the plasma jet is generated by a non-transferred arc, which hot plasma jet causes the cover layer to melt and the resulting plasma pressure displaces the molten material, thus creating the pilot hole. In the following, this process is referred to as plasma jet pre-drilling and is a fusion cutting type process. Since the molten material displaced from the pilot hole hardens on the surface of the topmost component layer and thus bonds with the cover layer, no chips or slugs whatsoever will remain from the pre-drilling step which would require additional treatment.

This is why the process of making pilot holes using a plasma jet pre-drilling unit, which has an inherently small overall size, does not require any additional extraction devices. This makes it easy to integrate it into production lines, for example as an attachment to a joining robot.

In the plasma jet pre-drilling method according to the invention, an electric arc is generated between an electrode, in particular a tungsten electrode, and the plasma nozzle. This arc ionizes at least part of the plasma that flows onto the cover layer in a plasma jet and thus provides the energy input into the cover layer, so as to cause selective melting of the top layer, which plasma jet is activated exclusively by the non-transferred arc. This largely prevents any damage or destruction of the base layer.

Switching off the arc will immediately disrupt the energy supplied through the plasma jet and the displaced melt will also solidify immediately as a result of the heat dissipation over the entire surface, leaving only the outline of a hole. The method of the invention is particularly suitable for cover layer material thicknesses of between 0.5 mm and 50 mm.

After the pilot hole has been made at the connecting position in the at least one cover layer, the joining operation can then be performed by inserting a connection element through the pilot hole into the base layer, with the position of the base layer relative to the cover layer remaining unchanged. Since a fully intact base layer is available for the connection, a large number of joining processes can be used, allowing the connection to be made, for example, by friction welding, punch riveting, nailing or screw driving, in particular flow drilling screw driving.

In addition to the mere hole forming process, plasma jet pre-drilling can contribute to a faster penetration of the base layer by the joining element, through additional energy input.

The electric arc burns continuously inside the plasma nozzle, which is usually designed as a water-cooled copper nozzle, and heats the gas, which then emerges as a hot plasma jet from the plasma nozzle and flows onto the cover layer.

In contrast to conventional plasma arc cutting, in which the cutting process is achieved by a transferred arc, less energy is introduced into the top layer, which thus allows specific pilot holes to be made in desired cover layers without severely damaging the underlying base layer. In particular, the cover layer does not have to be electrically conductive because the energy is transferred exclusively through the plasma gas.

In contrast to a mechanical process, plasma jet pre-drilling does not generate any significant process forces which would require correspondingly complex dimensioning of a pre-drilling/joining system.

According to another preferred embodiment, the system parameters are set such that a desired pilot hole diameter will be obtained. Since the dimension of the pilot hole is only dependent on process parameters, diameters can be adjusted or set within certain limits without, for example, having to change tools. This allows a high degree of flexibility in the pilot hole making process, also for different cover layers.

Preferably, a high-current process can be used to generate the plasma jet. This provides sufficiently high plasma jet power for the pilot hole making process. The preferred current for the generation of the electric arc using a high-current process is between 100 and 300 amperes.

According to the invention, the current intensity for the generation of the arc can be varied over the pre-drilling period t_{V}. In particular, the current used over a pre-arc period t_{V} is a pre-arc current I_{V}, over a main current period t_{H} it is a main arc current I_{H}. The main arc current I_{H} is higher than the pre-arc current I_{V}. Furthermore, the current used over a post-arc current period t_{N} can be a post-arc current I_{N} which is higher than the pre-arc current I_{V} and lower than the main arc current I_{H}.

A precise hole design can thus be achieved, because in particular in the post-arc current period, the melt of the cover plate produced during the main arc current period will only displace the melt radially due to the reduced power of the arc, and will not result in any further melting of the base layer.

The distance of the plasma nozzle from the cover layer is selected so as to allow sufficient heat transfer to the cover layer, while avoiding any melting of the base layer. It is advantageous to measure the distance of the plasma nozzle to the cover layer to be able to set the distance precisely.

To further influence the hole forming operation, the distance between the plasma nozzle and the cover plate can be varied during the hole forming operation. This allows the energy input and the effective area of the plasma jet to be adjusted as required.

Alternatively, a spacer may be provided. This element can be used as a support and as a spacing means and allows precise and reliable adjustment of the distance between the plasma nozzle and the cover layer with little effort. All inert gases, especially argon, are basically suitable as plasma gases.

Preferably using a molding element, the melt of the cover layer displaced by the plasma jet in the pilot hole forming operation is formed into a bead of a desired geometry that surrounds the pilot hole. The molding element can preferably be designed in such a way that the inner edge of a hollow cylinder is negatively rounded, i.e. has a groove.

In particular, for improved bead forming, the molding element can be rotated as the pilot hole is made by the plasma jet.

The bead enables a joining element which is inserted later and which has a recess in the underside of its head configured to accommodate the bead, in particular a groove, to produce a positive connection between the joining element and the cover layer also in the radial direction. This results in an increased transverse tensile strength. Moreover, this can improve the sealing of the joint.

The source for generating the electric arc generates the arc preferably with a DC voltage of about 20 volts, in particular of between 18 volts and 25 volts.

The plasma is preferably ejected from the plasma nozzle at a flow rate of about 20 liters per minute. Accordingly, the plasma pressure and the diameter of the plasma nozzle can be matched to each other so that sufficient heat energy can be transferred to generate the pilot hole.

Depending on the pilot hole to be produced, different plasma nozzles can be used, as will be described later in connection with the device.

According to another aspect of the invention, a device for joining a component connection comprising at least one cover layer and at least one base layer is provided, in which a pilot hole forming unit and a joining unit for joining the component layers via a joining element interact.

In accordance with the invention, the pilot hole forming unit comprises a plasma jet pre-drilling unit. The plasma jet pre-drilling unit comprises a plasma nozzle and an electrode, in which an arc is generated between the plasma nozzle and the electrode to at least partially ionize the plasma gas. The pilot hole is created by the hot plasma jet which flows onto the cover layer as described above.

The joining connection is made by means of the joining element, which connects to the intact base layer through the pilot hole made in the at least one cover layer. The joining unit can be a friction stir welding unit, a riveting unit, a screw driving unit or the like.

The plasma jet pre-drilling unit can preferably be a molding element for adjusting the melt produced in the pre-drilling operation, with the molding element being placed on the cover plate.

In particular, the molding element is arranged concentrically to the plasma nozzle and allows the plasma jet to pass through the molding element in the area of the pilot hole to be formed.

The molding element limits the distribution of the melt at least in the radial direction, but can also have a shape which also limits the distribution of the melt in the axial direction.

The molding element may have a negatively rounded area which allows molten material from the cover layer to be accommodated in this negative mold. A molding element designed in this way will produce a bead around the pilot hole, for which reason such a molding element is also referred to as a bead former.

The molding element preferably has at least one hole which is oblique, in particular perpendicular, to a central hole of the molding element through which the plasma jet is guided. Said at least one hole serves as a vent hole. This prevents plasma from accumulating inside the molding element and possibly unintentionally displacing or destroying the bead.

This enables the reflected plasma gas to escape even after the bead has made contact with the bead former.

This means that the molding element can be placed directly on the cover layer and thus serves as a spacer on the one hand and as a hold-down device on the other.

The molding element can preferably be arranged at a fixed distance or at an adjustable distance from the plasma nozzle. This allows the distance between the plasma nozzle and the cover layer to be adjusted in a simple and reliable manner during each pre-drilling operation.

Preferably, the molding element can also be of a cooled design and/or have a coating that will resist the application of a material. The design and cooling properties of the molding element may be such that it prevents heat dissipation of the plasma jet to the extent that sufficient heat will still be available for the melting process.

The plasma jet pre-drilling unit can also have a drive for rotating the molding element. Due to the rotation of the molding element, the melt displaced in the pre-drilling process can also result in a more uniform bead formation in overhead applications as used in production lines in the automotive industry, for example. In particular, the molding element can be designed to be rotatable relative to the plasma nozzle.

According to another advantageous embodiment, the molding element can be made of a high-temperature resistant metal or a ceramic.

A particularly advantageous design is achieved if the plasma nozzle and the molding element are integrally molded.

In another advantageous embodiment of the invention, the device can include a hold-down device, which will exert a hold-down force on the component layers during the pre-drilling process and/or during the joining process.

Use of the hold-down device will ensure a precise joining operation. In addition, the holding down force can act to urge any adhesive that may be present between the base layer and the cover layer, or between plural cover layers, away from the pilot hole to be created. This has the advantage that no adhesive vapors will be produced during pre-drilling and no energy will be required to remove the adhesive layer either. The hold-down force is preferably between 0.5 and 1 kN.

The joining unit and the pre-drilling unit can use a joint hold-down means of the device. Alternatively, the joining unit and/or the pre-drilling unit can have a hold-down device.

The plasma nozzle can have different nozzle orifices with different orifice diameters and orifice geometries. These affect the hole making behavior. For example, the nozzle orifice may have a single central circular cutout and/or plural circular cutouts that lie on the circumference of a circle.

According to another preferred embodiment, the device comprises a parameter memory which stores the operating parameters for the corresponding material combinations for the plasma jet pre-drilling unit.

An operator will thus easily be able to resort to appropriate values for the materials and dimensions of the layers to be joined and preferably also for the dimension of the pilot hole. This is a reliable way of making pilot holes in the cover layer only. The operator may also be a superordinate control unit.

In yet another preferred embodiment, the device may comprise at least one robot arm having the plasma jet pre-drilling unit and/or the joining device mounted thereon.

In a previously described manner, a component joint comprising at least one cover layer can thus be produced, in which the cover layer lying on a base layer has a bead surrounding a pilot hole. Extending through the pilot hole is the shaft of a connection element, which shaft is connected to at least one base layer, with its head configured such that the bead surrounding the pilot hole will be accommodated in a groove on the underside of the head. The cover layer is in particular harder than the base layer.

Additional advantages, features and possible applications of the present invention can be gathered from the following description in which reference is made to the embodiments illustrated in the drawings.

In the drawings:

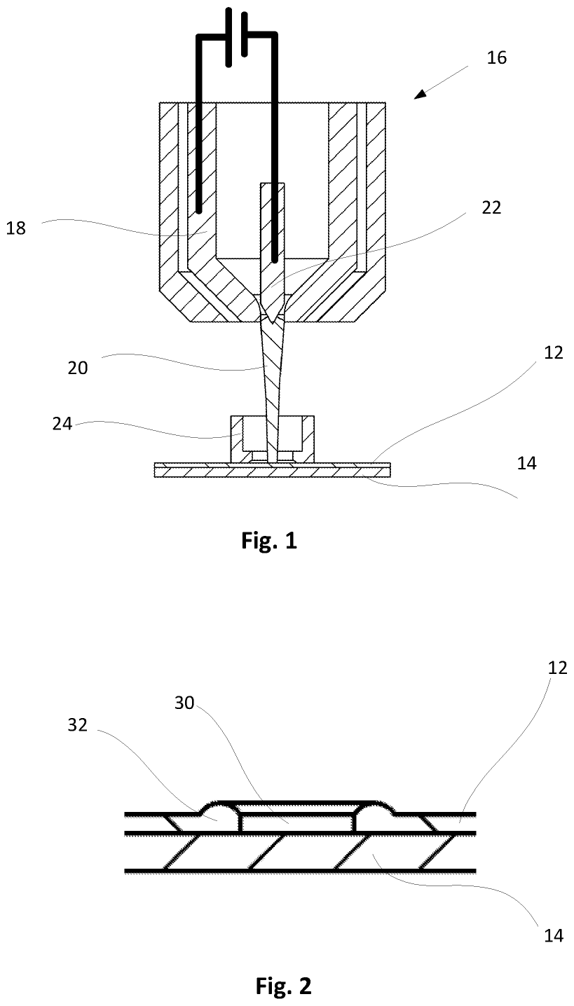

FIG. 1 is a schematic view of a plasma jet pre-drilling unit in the process of making a pilot hole using a concentrically arranged molding element;

FIG. 2 is a 2D sectional view of a pilot hole made in the cover layer;

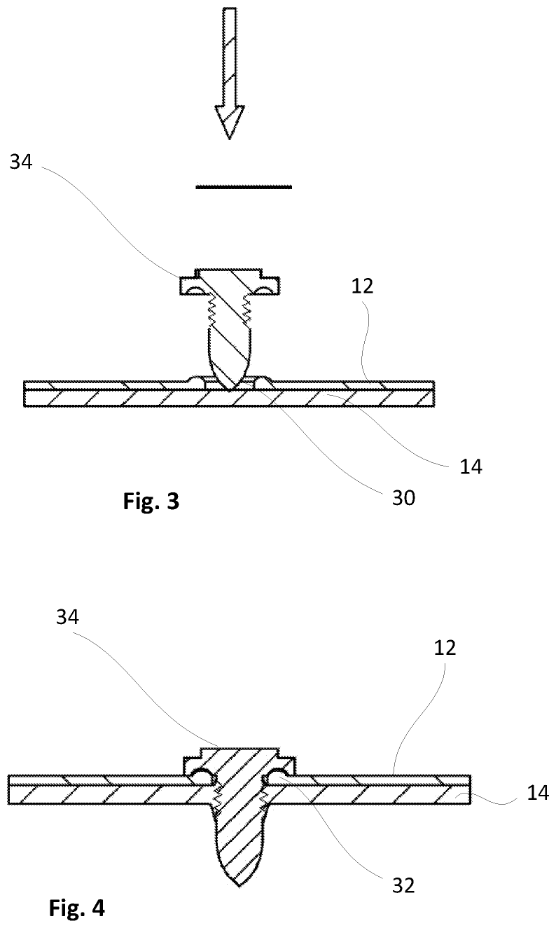

FIG. 3 is a schematic view of the joining step;

FIG. 4 is a view of a connection made according to the method;

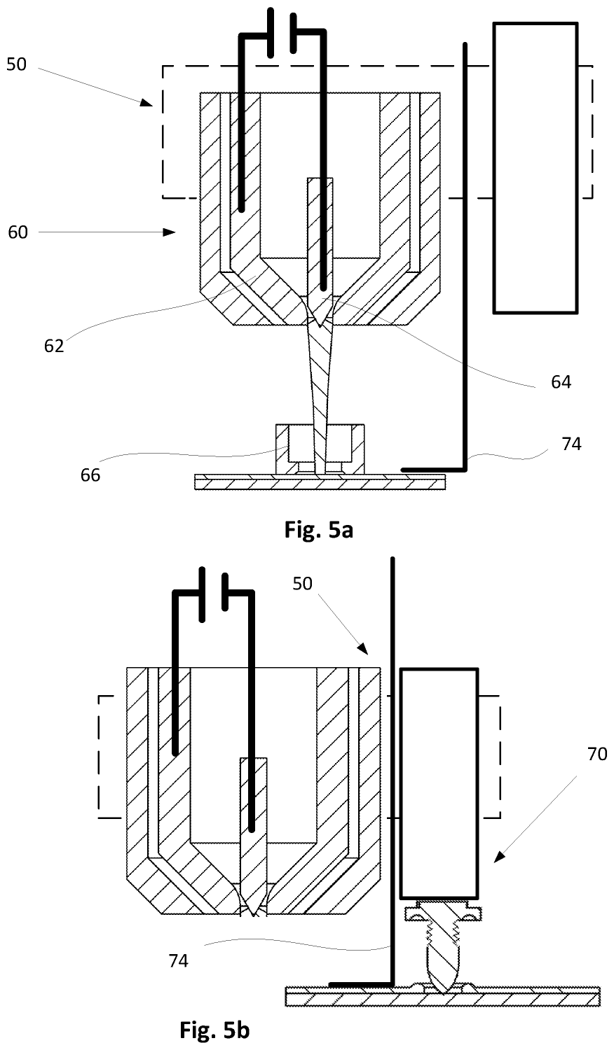

FIG. 5a is a view of a device according to the invention in the process of making of the pilot hole; and

FIG. 5b is a is a view of a device according to the invention in the process of making the connection;

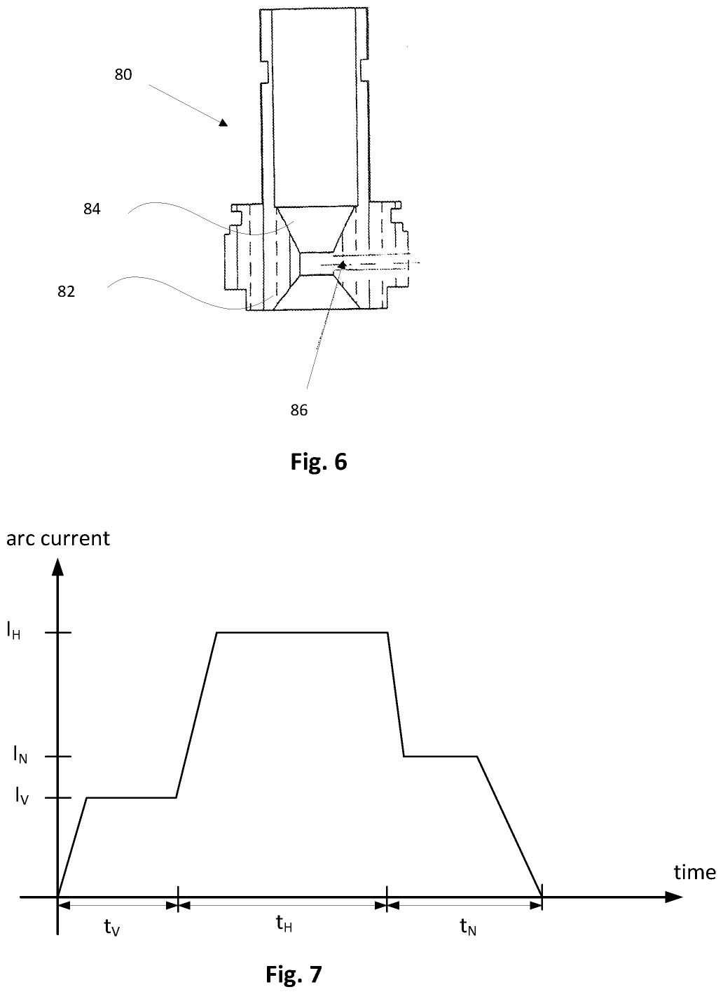

FIG. 6 is a view of a molding element with a vent hole integrally formed with a plasma nozzle;

FIG. 7 is a view of the electric arc current curve during the pre-drilling process.

FIG. 1 illustrates a first step in the joining method according to the invention. In accordance with this method, two superimposed component layers 12, 14 are to be connected with each other. In this embodiment, the cover layer 12 is harder than the base layer 14.

First, a pilot hole is made in the cover layer 12 using a plasma jet pre-drilling unit 16. The plasma jet pre-drilling unit 16 comprises a plasma nozzle 18 in which a plasma jet 20 is generated, with an electric arc being produced between a tungsten electrode 22 and the plasma nozzle 18. This is where the gas flowing through the plasma nozzle 18 is ionized and is then ejected onto the cover layer 12 in the form of a hot plasma jet 20. The plasma jet 20 acts to melt the cover layer 12 in the area of the pilot hole, with the plasma pressure radially displacing the molten material of the cover layer 12 from the area of the hole.

In this application, a molding element 24 is placed on the cover layer 12. This element 24 is designed as a hollow cylindrical sleeve and limits the course of the melt in the radial direction, thus creating an annular elevation in the form of a circumferential bead which is clearly delimited by the molding element 24.

The operating parameters of the plasma jet pre-drilling unit 16 are set according to the characteristics of the cover layer 12 to be pre-drilled.

FIG. 2 is an illustration of a pilot hole 30 in the cover layer 12 produced by the inventive method, which hole is surrounded circumferentially by a bead 32. The area of the base layer 14 located in the area of the pilot hole 30 has been preserved fully intact and its full material thickness can thus essentially be used for a connection with a joining element.

FIG. 3 is an illustration of the joining step according to the inventive method, in which a flow-hole forming screw 34 is inserted into the pilot hole 30 provided in the cover layer 12. As a next step, the flow-hole forming screw is screwed into the base layer 14 using pressure and rotation, in which process the screw cuts a rim hole and a thread, thus producing a screw connection as shown in FIG. 4.

FIG. 4 is a view of the component layers 12, 14 connected by the flow-hole forming screw 34, with the flow-hole forming screw 34 having been screwed into the base layer 14 and using its shoulder to press the cover layer 12 against the base layer 14 and positively locking it in the axial direction.

Provided in the underside of the head of the flow-hole forming screw 34 is an annular groove which is designed to accommodate the bead 32. This makes for an improved retaining effect in the transverse direction of the screw.

FIG. 5a is a view of a device 50 according to the invention for joining two component layers. This device 50 comprises a plasma jet pre-drilling unit 60 and a joining device 70.

As described above, the plasma jet pre-drilling unit 60 comprises a plasma nozzle 62 and a tungsten electrode 64. Using DC voltage and high current, an electric arc is generated between the tungsten electrode 64 and the plasma nozzle 62. In addition, a molding element 66 is positioned in front of the plasma nozzle 62 and is used to give the melt displaced by the plasma jet a desired contour.

Furthermore, the device 50 according to the invention comprises a control unit (not shown) which first positions the plasma jet pre-drilling unit 60 on the joint-forming layer, and subsequently, once the pilot hole has been made, positions the joining means at this site, as shown in FIG. 5b.

FIG. 5b shows the joining device 70 in place at the connection site and in the process of positioning a joining element for connection with the non-perforated softer base layer at this site.

This is a fast and inexpensive way of connecting component layers including a hard cover layer and a softer base layer by means of conventional joining processes and without having to use major process forces.

As shown as an example in FIGS. 5a and 5b, the joining device 70 and the plasma jet pre-drilling unit 60 can use a common hold-down unit 78 which will apply a hold-down force on the component layers both during the pre-drilling operation and during the joining operation.

FIG. 6 is a sectional view of a one-piece combination element 80 comprising a molding element 82 and a plasma nozzle 84. The conically tapering upper portion of the combination element forms the plasma nozzle 84, while the portion adjoining the plasma nozzle constitutes the molding element 82, with a vent hole 86 extending perpendicular to the axis of the combination element 80.

This allows the plasma gas to be guided through the plasma nozzle 84 in a bundled manner, with the counterflow reflected by the component being discharged through the vent hole 86.

The vent hole 86 in the molding element 82 largely prevents accumulation of plasma gas in the molding element, thus allowing a more precise formation of the pilot hole and of the bead surrounding the pilot hole.

The molding element 82 prevents the melt from exiting laterally, thus contributing to a more uniform formation of a bead surrounding the pilot hole made in the cover layer by the plasma jet.

FIG. 7 is an exemplary and qualitative illustration of the curve of the current I used to generate the electric arc during the pre-drilling operation. Over a pre-arc current period t_{V}, the arc is generated using a pre-arc current I_{V}. Over a main arc current period t_{H}, which essentially represents the time span in which the pilot hole is made in the cover layer, the arc is generated using a main arc current I_{H}. This is in particular 200 A. Once the pilot hole has been made in the cover layer, i.e. after the main arc current period, the arc is generated using a post-arc current IN over a post-arc current period. The post-arc current is lower than the main arc current and of an intensity that will suffice to merely displace the melt laterally without, however, making a hole in the base layer. Especially in combination with a molding element, this allows a relatively precise bead contour to be produced from the molten material of the cover layer.

The above-mentioned current periods are adapted to the materials and the thicknesses of the at least one cover layer and of the base layer.

1. A method for connecting at least two component layers by means of a connection element, said connection comprising at least one cover layer and at least one base layer, wherein a pilot hole in the form of a through-hole is made in the at least one cover layer, and the at least one base layer is not pre-drilled in the region of said pilot hole, with a connection element having a shoulder being connected to the base layer through the pilot hole in the cover layer, and said connection element holding the cover layer in place by means of its shoulder, characterized in that a pilot hole is made only in the at least one cover layer, which is at least temporarily retained on the base layer, and, once the pilot hole has been made in the cover layer, the connection element is guided through the cover layer and connected to the non-pre-drilled base layer, said pilot hole being formed by a plasma jet.

2. The method according to claim 1, characterized in that the plasma jet is generated by means of a non-transferred electric arc, wherein the hot plasma jet causes the cover layer to melt and the plasma pressure acts to displace the molten material, thus creating the pilot hole.

3. The method according to claim 1, characterized in that the material displaced when making the pilot hole is used to form a concentric bead during the displacement process.

4. The method according to claim 3, characterized in that the concentric bead is produced by means of a molding member which rotates when the pilot hole is made by the plasma jet.

5. The method according to claim 1, characterized in that the distance between the plasma nozzle and the cover plate is varied during hole forming.

6. The method according to claim 1, characterized in that the current used to generate the electric arc is varied over the pre-drilling period t_{V}, which current is a pre-arc current I_{V} over a pre-arc period t_{V}, over a main current period it is a main arc current I_{H}, which is higher than the pre-arc current I_{V}, and over a post-arc period t_{N} it is a post-arc current I_{N}, which in particular is higher than the pre-arc current I_{V} and lower than the main arc current I_{H}.

7. The method according to claim 1, characterized in that the connection of the connection element to the base layer is effected using friction welding, nailing, friction nailing or hole-forming screw driving, in particular flow drilling screw driving.

8. A device for joining a component connection, comprising at least one cover layer and at least one base layer, wherein the device comprises a pilot hole forming unit and a joining unit, which interact to join the component layers by means of a connection element, and wherein the pilot hole forming unit makes a pilot hole in the at least one cover layer and the joining device connects a connection element to the still complete base layer via said pilot hole, characterized in that said pilot hole making unit comprises a plasma jet pre-drilling unit comprising a plasma nozzle having a nozzle orifice from which a hot plasma jet can be ejected.

9. The device according to claim 8, characterized in that the plasma jet pre-drilling unit generates a plasma jet solely by means of a non-transferred arc.

10. The device according to claim 8, characterized in that a molding element is arranged concentrically to the plasma nozzle, which element in particular spaces the plasma nozzle from the cover layer.

11. The device according to claim 10, characterized in that the molding element is designed in such a way that it limits the displacement of the melt at least in the radial direction, in particular also in the axial direction.

12. The device according to claim 10, characterized in that the molding element is formed from a high-temperature-resistant metal or a ceramic material.

13. The device according to claim 10, characterized in that the molding element is designed to be rotatable.

14. The device according to claim 10, characterized in that the molding element has at least one hole which is oblique, in particular perpendicular, relative to a central hole of the molding element and serves as a vent hole.

15. The device according to claim 10, characterized in that the plasma nozzle and the molding element are designed as a structural unit, in particular as a combination element.

16. The device according to claim 10, characterized in that the molding element has a coating/an alloy.

17. The device according to claim 8, characterized in that the nozzle orifice has a central circular cutout.

18. The device according to above claim 8, characterized in that the nozzle orifice has a plurality of circular cutouts lying on the circumference of a circle.

19. The device according to claim 8, characterized in that a hold-down device is provided which is used to apply a hold-down force to the component layers during the pilot hole making operation and during the joining operation.

20. The device according to claim 8, characterized in that the joining unit and/or the pilot hole making unit are provided with a hold-down device.

21. The device according to claim 8, characterized in that a control unit is provided that interacts with a parameter memory which stores operating parameters depending on the material properties of the component layers to be joined.

22. The device according to claim 21, characterized in that the operating parameters are dependent on the size of the pilot hole.

23. A component connection, comprising at least one cover layer, wherein said cover layer has a bead surrounding a pilot hole, with the shaft of a connection element extending through said pilot hole, which shaft is connected to a base layer, said connection element having a head with a shoulder, said head of the connection element is designed such that a groove provided on the underside of the head accommodates the bead surrounding the pilot hole.
